(19) United States
(12) Patent Application Publication
(10) Pub. No.: US 2009/0006253 A1
(43) Pub. Date: Jan. 1, 2009

(54) System and method for data comparison and reconciliation by a business customer using an electronic bill presentment system

(76) Inventors: Mark Bresnan, Newtown, CT (US); Kenneth E. McDonald, Nesconset, NY (US); John R. Decker, Lakeville, MN (US); Rebecca E. Carvell, Brookfield, CT (US); Dennis J. Boylan, Painesville, OH (US)

Correspondence Address: PITNEY BOWES INC.;35 WATERVIEW DRIVE, P.O. BOX 3000, MSC 26-22, SHELTON, CT, 06484-8000, US

(21) Appl. No.: 11/824,244

(22) Filed: Jun. 29, 2007

(51) Int. Cl. G06Q 30/00

(52) U.S. Cl. 705/40

(57) ABSTRACT

A method for flexible automated comparison of a biller's data with the business customer's data via the EBPP system that is in place between the two. The biller stores a first set of customer billing data in its EBPP database. The customer stores a second set of customer billing data reflecting its most current information. The biller presents an electronic statement to the customer based on the first set of customer billing data. The customer selects one or more of the invoices for comparison and billing data fields to perform comparison on. The customer transmits an input file to the biller reflecting local data. The biller EBPP system then compares the customer's local billing data with the EBPP data. The step of comparing further includes selecting a comparison set of data from the EBPP data based on the one or more invoices selected by the customer. The comparison is performed on the fields indicated for comparison by the customer. The type of comparison to be done may also be indicated in the input file. The EBPP system of the biller then provides a comparison report to the customer showing instances where the comparison set and the second set of data are different.

### FIELD OF THE INVENTION

The present invention relates to a new feature for an electronic bill presentment system that allows a customer to check its own data pertaining to invoices against the corresponding data of the biller.

### BACKGROUND OF THE INVENTION

Electronic bill presentment and payment (EBPP) systems are becoming increasingly popular for allowing a business to communicate with its customers. In lieu of paper invoices, an EBPP system allows a customer to view and pay bills electronically, typically using a web browser interface to access a biller's EBPP system over the Internet.

EBPP systems are not limited to serving individuals and households as customers. They are also used in connection with business to business transactions. In those cases, the invoice data for the business customer may be much more extensive than data associated with individuals. For example, an insurance company may submit an invoice to a business customer for insurance coverage supplied to the business customer's employees. Such an invoice might include a listing of employee names, employee ID numbers, coverage type, and amounts due for the types of coverage provided. Thus, it can be a time consuming process for business customers to review these lengthy and data intensive invoices.

Both the insurer biller and the business customer maintain listings of current employees and applicable coverage types. From time to time, the business customer must provide updated employee data to the insurer biller to reflect the current employee roster and insurance selections.

### SUMMARY OF THE INVENTION

The present invention provides for flexible automated comparison of the biller's EBPP data with the business customer's data via the EBPP system that is in place between the two entities. The biller stores a first set of customer billing data in its EBPP database. The customer stores its own second set of customer billing data reflecting its most current information. The customer's most recent second set of data may not be reflected in the biller's first set of data. Accordingly, the present invention provides a way to identify differences between the two sets of data. By automatically identifying differences in the data, customers can confirm the accuracy of invoices in the EBPP system and take appropriate remedial action when discrepancies occur.

The biller presents an electronic statement to the customer based on the first set of customer billing data. The electronic statement includes one or more invoices. The customer selects one or more of the invoices for comparison. The customer also selects which billing data fields to perform comparisons on via an interface in the electronic statement provided by the biller. The customer then transmits an input file to the biller. The input file includes a second set of customer billing data and an indication of the one or more invoices selected for comparison and an indication of which fields are to be compared.

The biller EBPP system then compares the second set of customer billing data with the first set of customer billing data. The step of comparing also includes selecting line items of data from the first set of customer billing data based on the one or more invoices selected by the customer. The comparison is performed on the data fields indicated for comparison by the customer. The EBPP system of the biller then provides a comparison report to the customer showing instances where the comparison set and the second set of data are different.

### BRIEF DESCRIPTION OF THE DRAWINGS

FIG. 1 depicts an arrangement of EBPP communication between a biller and its business customers.

FIG. 2 is a high level process for generating comparisons.

FIG. 3 depicts a flow diagram for generating a comparison report.

FIG. 4 depicts exemplary logic for performing a comparison.

FIG. 5 depicts an exemplary screen display including a listing of invoices and review options.

FIG. 6 depicts an exemplary screen display including a listing of comparison files.

FIG. 7 depicts an exemplary screen display that allows a user to identify data fields for different comparison criteria.

FIG. 8 depicts an exemplary table showing comparison results.

### DETAILED DESCRIPTION OF THE PREFERRED EMBODIMENT

Business customers of EBPP billers may benefit from reconciling the line item data in their statements to data that they have on file in their own systems. The improved EBPP method described herein allows business customers to upload a file of their local data and compare it to the line items associated with a statement in the EBPP system. This comparison will create a report that can be reviewed by the business customer and downloaded to their local PC.

There are many different types of EBPP relationships where a system embodying the present invention may be beneficial for a business customer. An example of an insurance company that invoices business customers will be described. However, it will be understood by one skilled in the art that the invention is not limited to insurance invoices.

In this illustrative example, an insurance company offers business customers group plans for their employees. The billing amount for the business customer is based on how many employees are enrolled in the plan and what their coverage is. An insurance company may bill a business customer monthly. The bill lists the types of insurance products offered to that business customer (medical, dental and life). In the base product, these would most likely be organized as separate sections within the invoices and within the line item module of the biller's database. Each employee of the business customer may appear in one or more of the sections.

That is, the same employee, Joe, may have enrolled for medical and dental coverage, but declined life insurance coverage. Thus, Joe's employee ID would appear in the Medical Section and the Dental Section, but be absent from the Life section of the bill. In addition to the basic sections of Medical, Dental and Life, Joe may enroll for Medical coverage for just himself, himself and his spouse, or himself and his entire family. Each coverage type has a progressively higher billing rate depending upon which coverage Joe selects.

For this example, Joe is married and currently has enrolled for coverage that includes himself and his spouse. Joe and his wife recently had a baby and need to change their coverage to family coverage. The last bill from the insurance company to the business customer included Joe in the Medical plan, but only billed him at the rate for him and his spouse. Joe now requires a change to the group plan to cover his new baby.

When Joe informs his employer of the required change, the employer needs to also inform the insurance company, which may have an impact on the amount paid for the recent statement.

This new feature for an EBPP system allows the business customer to create a file based on the records they have for their employees and to compare it to the recent line item data stored with a statement in the EBPP system. In this case, the file created would have Joe in two sections: Medical and Dental. When comparing the file created by the business customer to the line item data of the statement, the system would flag the difference in the amount due for Joe's record in the Medical section of the document.

In addition to changes in coverage, businesses often terminate and hire new employees. These comparisons may also be part of the file comparison.

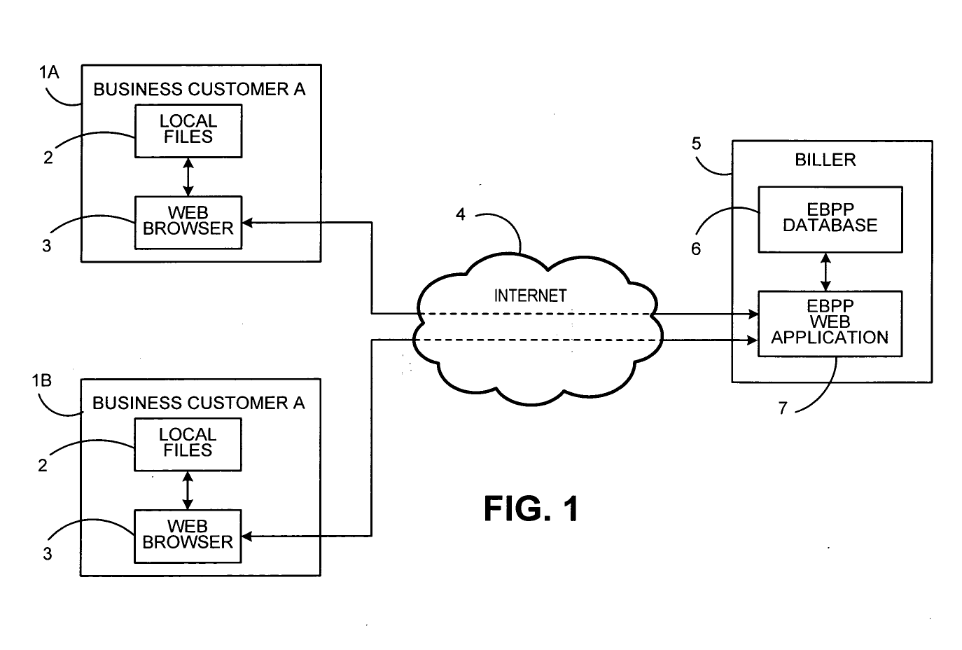

FIG. 1 depicts an EBPP system with which the present invention may be used. Business customers 1A and 1B communicate with a biller 5 via the Internet 4. Conventional web browsers 3 receive and display invoices transmitted by an EBPP web application 7 located on servers run by biller 5. In this embodiment, the business customers 1A and 1B each have local files 2 that include data pertinent to their respective transactions with the biller 5. The biller 5 maintains an EBPP database 6 that includes data pertaining to invoices to be sent to the customers 1A and 1B. In a conventional system, the EBPP database 5 must be periodically updated with the latest data from the customers 1A and 1B, although such updating is not conventionally handled through an EBPP interface. Web browser 3 is conventionally run on a standard personal computer, equipped with standard browser software. The EBPP web application 7 is typically run on a conventional web server computer with access to the Internet 4.

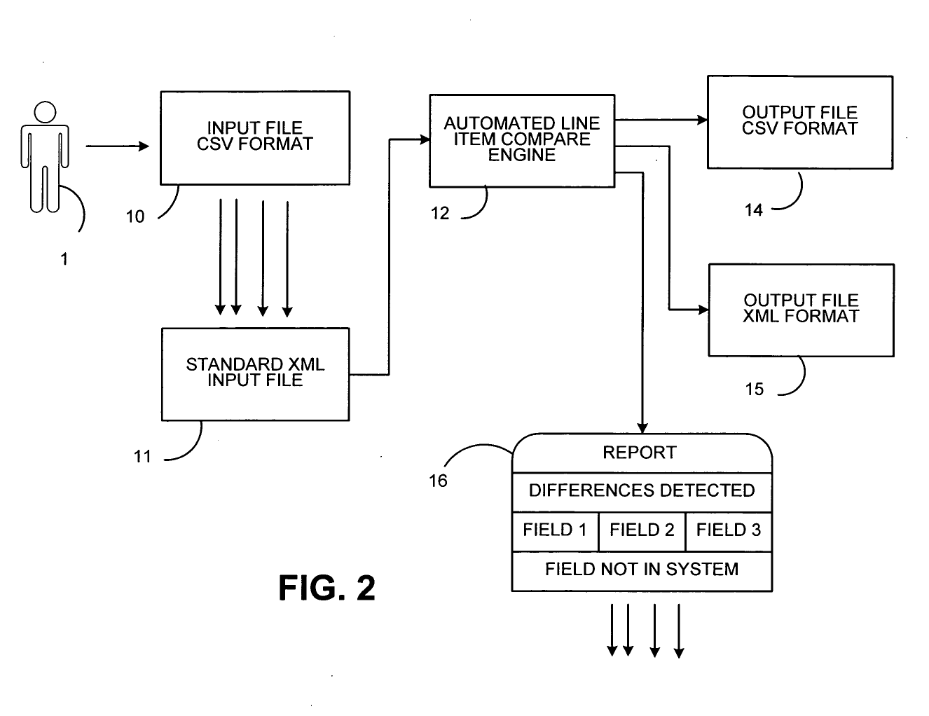

FIG. 2 depicts a high level design scheme for a preferred embodiment. A customer 1 generates an input file 10 that includes the local data that is to be compared with the biller's data. In the preferred embodiment, the comparison engine 12 operates on data that is in XML format. In the example of FIG. 2, however, the customer 1 has created a file 10 in comma separated value (CSV) format. If the customer 1 does not create an XML input file, then an additional step is taken to convert the input file into a standard XML input file 11 using an XML mapping configuration file that maps CSV to XML. This standard file 11 is then provided to the automated line item compare engine 12.

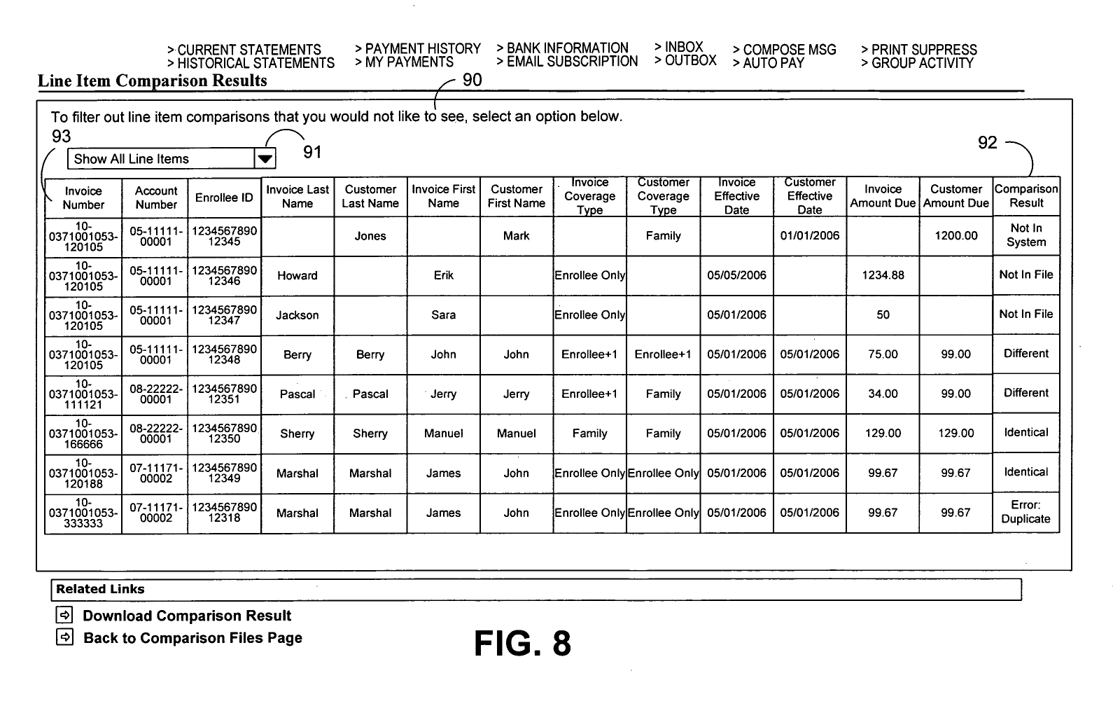

In the embodiment of FIG. 2, there are three potential outputs from the line item compare engine 12, depending on the preference and choice of the customer. First, the output can be converted back to CSV format in file 14. An output file 15 can be provided in XML format. Finally, the output can be provided as a formatted report 16 arranged in a table for simplified review by the customer 1. The formatted report 16 may be presented via the customer web browser 3. An exemplary report 16 can be seen in FIG. 8. The customer 1 may elect to receive any or all of these three outputs.

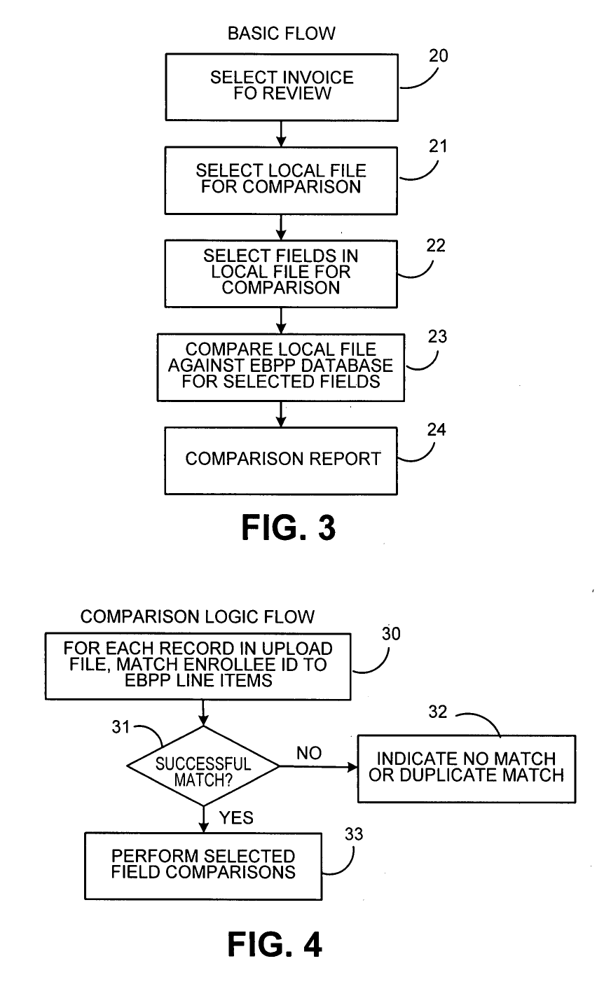

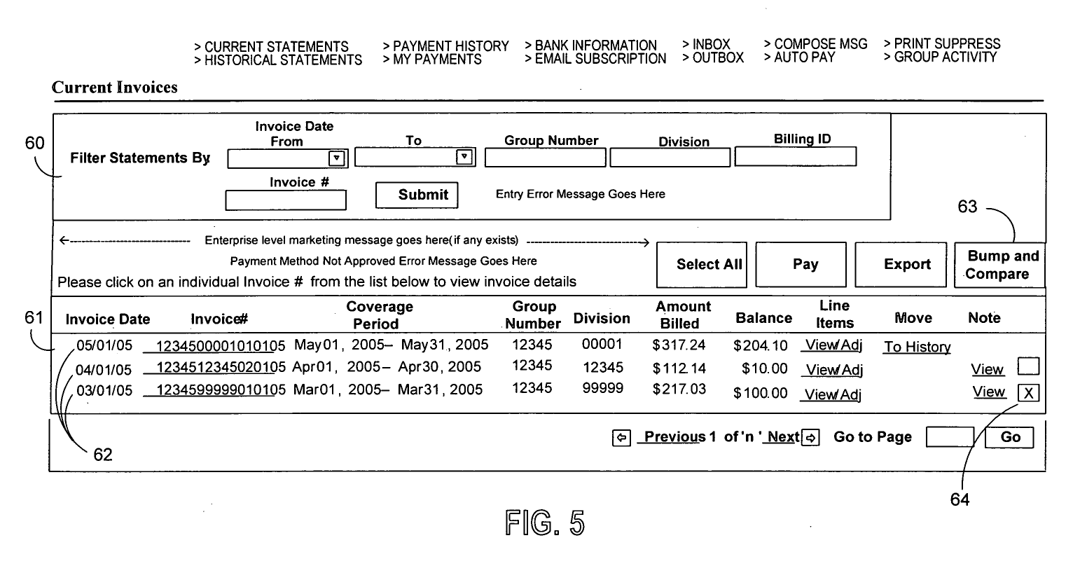

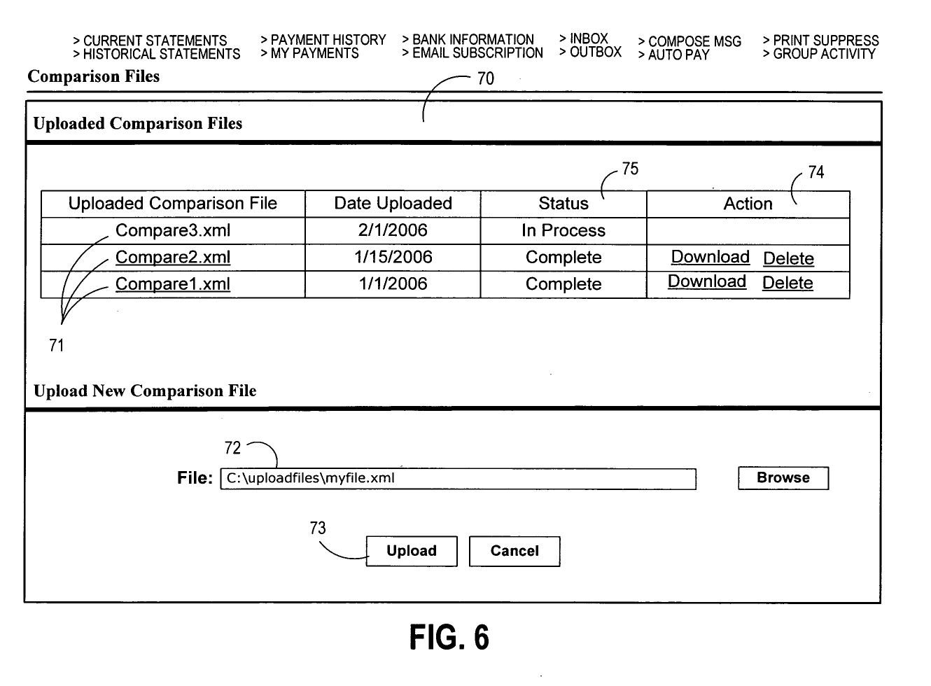

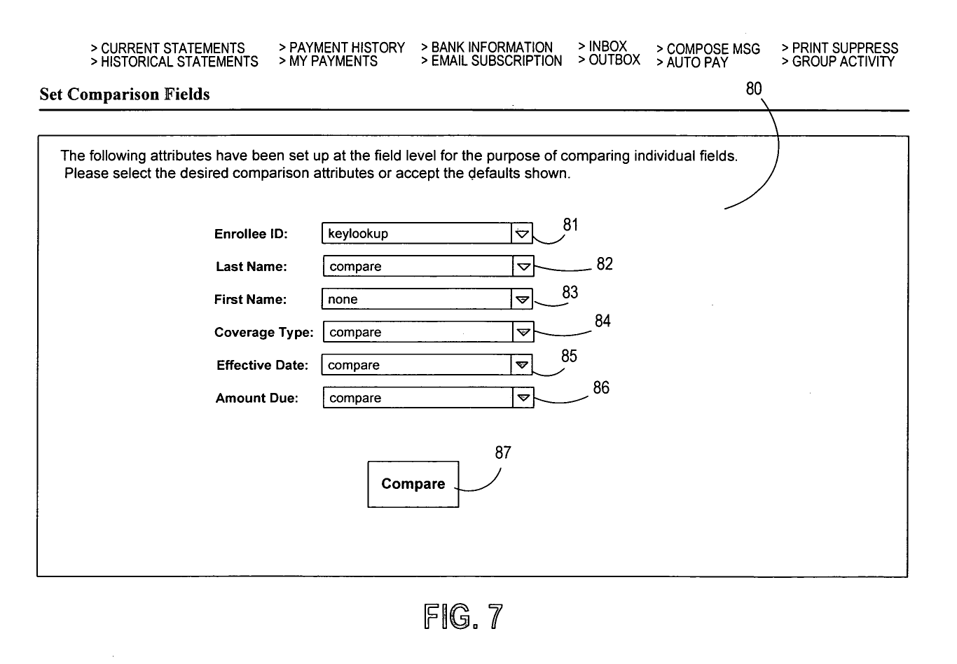

FIG. 3 depicts exemplary operation of the system from the perspective of the business customer. In a first step 20, the customer selects an invoice for review from a listing of invoices provided on the EBPP system by the biller. An example of an interface for selecting invoices is shown in FIG. 5. After the invoice has been selected, the customer identifies a local file, external to the EBPP system that includes data that is desired for comparison against the biller's EBPP data (step 21). An interface for selecting a local file is shown in the lower portion of FIG. 6. Via the EBPP interface, the customer selects which fields are to be compared against the biller's EBPP data (step 22). An exemplary interface for selecting actions to be performed on fields is shown in FIG. 7. At step 23, the local file is uploaded to the biller's computers is compared to the biller's EBPP using the fields as selected by the customer for comparison. Finally, a comparison report is generated and is provided by the EBPP system to the customer (step 24). An exemplary report is depicted in FIG. 8.

FIGS. 5-7 depict exemplary EBPP interface screens which are presented to the customer in a preferred implementation of the invention. FIG. 5 depicts a screen shot 60 that includes a list 61 of invoices 62 that can be selected by the customer. In this embodiment, invoices 62 are selected for comparison by checking the boxes 64 next to the respective invoice. Then, by clicking the “Bump and Compare” button 63, further options for comparison shown in FIGS. 6 and 7 will be displayed.

In FIG. 6, a screen shot 70 shows a list of comparison files 71 that have already been created, or that are in the process of being created. The status of the comparison file is shown in column 75. Further actions that can be taken on the completed comparison files are available to be selected from column 74. If “Download” is selected from column 74, the comparison file is downloaded from the biller's EBPP system to the customer's computer. If “Delete” is selected from column 74, the comparison file is deleted.

Below the listing of comparison files 71, an interface is provided for identifying local files 72 from the customer's computer system that are to be uploaded for comparison with the biller's EBPP data. The local file 72 is input in the field shown, and the respective file will be uploaded to the EBPP system when the “Upload” button 73 is selected.

The standard upload file format will be XML because it's extensible and quickly becoming industry standard for data exchange. Its format will mirror the data found in the standard line item tables in the EBPP system. In addition, the biller may wish to allow business customers to upload many different file formats. If this is desired, an additional step is required to transform the file into the standard XML version, as discussed above in connection with FIG. 2. Another exemplary format, in addition to CSV, for the upload file could be EDI820. The system will also provide support for uploading line item compare data as a comma delimited flat file.

### Sample Upload File

The following is an example of an upload file that reflects an XML schema compatible for use with the present invention.

```
<LineItem_Compare>
  <Section_Record>
    <Identifier action=“keylookup”>xyx</Identifier>
    <Description action=“none”></Description>
    <AmountDue action=“none”>127.69</AmountDue>
    <LineItem_Record>
      <Identifier action=“keylookup”>0568</Identifier>
      <Description action=“none”/>
      <AmountDue action=“compare”>58.68</AmountDue>
      <TaxAmountDue action=“none”/>
    </LineItem_Record>
    <LineItem_Record>
      <Identifier action=“keylookup”>0569</Identifier>
      <AmountDue action=“compare”>69.01</AmountDue>
      <TaxAmountDue action=“none”/>
    </LineItem_Record>
  </Section_Record>
</LineItem_Compare>
```

FIG. 7 is a screen shot of an interface whereby the customer can select the comparison attributes for comparing the respective fields of the local data with the biller's EBPP data. These selected attributes instruct the EBPP comparison engine how to interpret the data it finds in a data element.

There are three valid actions for data fields 81-86 depicted in FIG. 7:
keylookup
compare
none.

A data element with “keylookup” as an action is used to find a row in the Section or LineItem table. As mentioned in the exemplary scenario, a Section table includes the high level data differentiating the Medical, Dental and Life portions of the EBPP data. LineItem tables include the specific line items of data associated with particular billable enrollees in the database. In a preferred embodiment, the field marked with keylookup is the Identifier field 81. The design of the Line Item module expects that the Identifier field will uniquely identify a section in the Section table or, within a given section, a line item in the LineItem table. This doesn't imply that the same value for Identifier cannot appear in more than one line item. For line items, the identifier field is unique within a section. So, in our use case example from earlier in the document, Joe's identifier would be the same for both the medical and dental sections of the file, but each record is uniquely identified because they appear in different sections. Thus, in this embodiment, “keylookup” is used to retrieve and organize data in connection with the ID numbers for particular enrollees within the EBPP invoice data.

The “compare” action, as seen for fields 82 and 84-86 in FIG. 7, instructs the system to compare the value found in the field with the corresponding field from the database. For example, let's assume that the system found the following line in an uploaded file:

<AmountDue action=“compare”>58.68</AmountDue>

The system would find a row in the LineItem table using the data element(s) marked with the keylookup action (in FIG. 7, “Enrollee ID”). Once the system located the relevant row in the LineItem table, it would compare the amount that is in the AmountDue field with the value supplied in the file. In this case, the amount is $58.68. If the amount found in the line item table was $25.00, the system records the respective amounts due in a comparison table and sets a flag indicating that differences were detected in another field of the comparison table.

The “none” action, as selected for field 83 in FIG. 7, will simply record the value found in the data element into the corresponding field in the comparison table. A flag is set indicating that no comparison was done for that field in the comparison table.

When the appropriate actions are set for fields 81-86, the “compare” button is pressed to include those comparison criteria as part of the comparison file that is sent to the biller's EBPP system.

FIG. 8 depicts a screenshot 90 of a comparison results table 93. The contents of the table can be filtered via a drop down selection menu 91. Menu 91 may include options to show all compared line items, to show only differences, to show only identical items, or to show only duplicate items.

Table 93 shows the local customer data in columns next to the corresponding invoice data from the biller's EBPP system. Column 92 shows the comparison results for the compared line items. The “Not In System” indicator in column 92 indicates that the local customer data includes data for an employee that is not in the biller's EBPP data. The “Not In File” indicators in column 92 indicate that the EBPP data includes data that is not found in the local file from the customer.

The “Different” indicator in column 92 means that, for fields for which “compare” was selected on the interface screen of FIG. 7, at least one of those fields is different between the two sets of data. The “Identical” indicator in column 92 means that for all fields for which “compare” was selected from FIG. 7, the fields are all the same.

Where the comparison criterion of “none” was selected in FIG. 7, that field is not used for comparison. Thus, in the exemplary report of FIG. 8, where the first name field was given a “none” comparison attribute, the records for Mr. Marshal are considered to be identical, even though invoice data has a first name of “James,” and the customer records have a first name of “John.”

The standard download file format preferably is XML because it's extensible and industry standard for data exchange. Its format will mirror the data stored in the standard line item tables in the EBPP system.

### Sample Download File

The following is an example of a download file that reflects an XML schema compatible with an EBPP system.

```
<LineItem_CompareResults>
  <Section_Record result=“Different”>
    <Identifier originalvalue=“xyx” comparevalue=“xyx” result=“NotCompared”/>
    <Description originalvalue=“Some Value” comparevalue=“” result=“NotCompared”/>
    <AmountDue originalvalue=“127.69” comparevalue=“127.69” result=“NotCompared”/>
    <LineItem_Record result=“InFileNotInSystem”>
      <Identifier originalvalue=“” comparevalue=“0568” result=“NotApplicable”/>
      <Description originalvalue=“” comparevalue=“” result=“NotCompared”/>
      <AmountDue originalvalue=“” comparevalue=“58.68” result=“NotCompared”/>
      <TaxAmountDue originalvalue=“” comparevalue=“” result=“NotCompared”/>
    </LineItem_Record>
    <LineItem_Record result=“Different”>
      <Identifier originalvalue=“0569” comparevalue=“0569” result=“ NotApplicable ”/>
        <Description originalvalue=“Sample Line Item Description” comparevalue=“” result=“NotCompared”/>
      <AmountDue originalvalue=“69.00” comparevalue=“69.01” result=“Different”/>
      <TaxAmountDue originalvalue=“69.00” comparevalue=“” result=“NotCompared”/>
    </LineItem_Record>
    <LineItem_Record result=“InSystemNotInFile”>
      <Identifier originalvalue=“0571” comparevalue=“” result=“ NotApplicable ”/>
      <Description originalvalue=“Sample Line Item Description” comparevalue=“” result=“NotCompared”/>
      <AmountDue originalvalue=“71.50” comparevalue=“” result=“NotCompared”/>
      <TaxAmountDue originalvalue=“71.50” comparevalue=“” result=“NotCompared”/>
    </LineItem_Record>
    <LineItem_Record result=“InFileNotInSystem”>
      <Identifier originalvalue=“” comparevalue=“abc” result=“ NotApplicable ”/>
      <Description originalvalue=“” comparevalue=“” result=“NotCompared”/>
      <AmountDue originalvalue=“” comparevalue=“25.67” result=“NotCompared”/>
      <TaxAmountDue originalvalue=“” comparevalue=“25.67” result=“NotCompared”/>
    </LineItem_Record>
    <LineItem_Record result=“NotDifferent”>
      <Identifier originalvalue=“def” comparevalue=“def” result=“ NotApplicable ”/>
      <Description originalvalue=“Some Description” comparevalue=“” result=“NotCompared”/>
      <AmountDue originalvalue=“25.67” comparevalue=“25.67” result=“NotDifferent”/>
      <TaxAmountDue originalvalue=“25.67” comparevalue=“25.67” result=“NotCompared”/>
    </LineItem_Record>
  </Section_Record>
</LineItem_CompareResults>
```

FIG. 4 depicts exemplary logic for performing comparisons between the customer's local data and the biller's EBPP data. In step 30, the “keylookup” action is performed on the Enrollee ID field to find records in the section tables and in the line item tables that include the Enrollee ID's that are included in the customer's upload file. In the preferred embodiment, line item data is also sorted and selected based on the invoice numbers for the invoices selected for comparison. If a successful match (step 31) is made between an upload file line item and an EBPP line item, then the comparisons of the respective fields are made in accordance with the actions that were selected via interface screen 80 (FIG. 7). If no match is found for the Enrollee ID, or if duplicate matches are found, that indication is also entered into the comparison table (step 32), and the results can be displayed as “Not in File, “Not in System,” or “Error: Duplicate,” as shown in column 92 in FIG. 8.

While the present invention has been described in connection with what is presently considered to be the most practical and preferred embodiments, it is to be understood that the invention is not limited to the disclosed embodiment, but, on the contrary, is intended to cover various modifications and equivalent arrangements included within the spirit and scope of the appended claims.

What is claimed is:

1. A method by a biller for providing automated comparison of billing data between the biller and a customer in an electronic bill presentment system, the method comprising:
storing a first set of customer billing data in an EBPP database at the biller;
presenting an electronic statement based on the first set of customer billing data to the customer, the electronic statement including one or more invoices, the electronic statement further including selectable indicators by which the customer can select one or more of the invoices for comparison;
providing a field comparison selection interface to the customer as part of the electronic bill presentment system, whereby the customer can select which billing data fields to perform comparison on;
receiving an input file from the customer, the input file including a second set of customer billing data originating from the customer, the input file further including an indication of the one or more invoices selected by the customer for comparison and an indication of which fields were selected by the customer for comparison;
comparing the second set of customer billing data with the first set of customer billing data, the step of comparing further comprising:
identifying line items of data from the first set of customer billing data based on the one or more invoices selected by the customer for comparison;
performing a comparison of the fields of the identified line items of the first set of data and line items of the second set of data based on the fields indicated for comparison by the customer; and
providing a comparison report to the customer showing instances where compared data fields are different.

2. The method of claim 1 wherein the step of providing the field comparison selection interface further includes providing an option to indicate fields for which no comparison is to be made.

3. The method of claim 1 wherein the step of providing the field comparison selection interface further includes providing an option to indicate fields that will serve as key lookup fields.

4. The method of claim 1 further comprising a step of providing a download comparison file of comparison data from the first set and the second set of data.

5. The method of claim 1 wherein the step of receiving the input file from the customer includes converting a flat file to an XML format.

6. A method by a customer for automated comparison of billing data between a biller and the customer in an electronic bill presentment system, the method comprising:
storing a second set of customer billing data at the customer;
receiving an electronic statement based on a first set of customer billing data from the biller, the electronic statement including one or more invoices,
selecting from the electronic statement one or more of the invoices for comparison;
selecting which billing data fields to perform comparison on from a field selection interface;
sending an input file from the customer to the biller, the input file including the second set of customer billing data originating from the customer, the input file further including an indication of the one or more invoices selected by the customer for comparison and an indication of which fields were selected by the customer for comparison;
receiving a comparison report from the biller showing instances where the first set and the second set of data are different for the selected invoices for the selected fields.

7. The method of claim 6 wherein the step of selecting the billing data fields further includes indicating fields for which no comparison is to be made.

8. The method of claim 6 wherein the step of selecting the billing data fields further includes indicating fields that will serve as key lookup fields that will be used for determining data within the first set of data of the biller to compared with the second set of data of the customer.

9. A method for providing automated comparison of billing data between a biller and a customer in an electronic bill presentment system, the method comprising:
storing a first set of customer billing data in an EBPP database at the biller;
storing a second set of customer billing data at the customer
presenting an electronic statement based on the first set of customer billing data from the biller to the customer, the electronic statement including one or more invoices,
selecting one or more of the invoices for comparison by the customer;
selecting which billing data fields to perform comparison on by the customer via an interface in the electronic statement provided by the biller;
transmitting an input file from the customer to the biller, the input file including a second set of customer billing data originating from the customer, the input file further including an indication of the one or more invoices selected by the customer for comparison and an indication of which fields were selected by the customer for comparison;
comparing the second set of customer billing data with the first set of customer billing data at the biller, the step of comparing further comprising:
selecting line item data from the first set of customer billing data based on the one or more invoices selected by the customer for comparison;
performing a comparison of the fields of the selected line item data and the second set of data based on the fields indicated for comparison by the customer; and
providing a comparison report to the customer showing instances where the first set and the second set of data are different.

10. The method of claim 9 wherein the step of selecting data fields for comparison includes indicating fields for which no comparison is to be made.

11. The method of claim 9 wherein the step of selecting data fields for comparison further includes indicating fields that will serve as key lookup fields that will be used for determining data to be included in the comparison set of data.

12. The method of claim 9 further comprising a step of providing a download comparison file of comparison data from the first set and the second set of data.

13. The method of claim 9 further including a step of receiving the input file from the customer and converting the input file from a flat file format to an XML format.
